(19) United States
(12) Patent Application Publication
(10) Pub. No.: US 2021/0181838 A1
(43) Pub. Date: Jun. 17, 2021

(54) INFORMATION PROVIDING METHOD AND ELECTRONIC DEVICE FOR SUPPORTING THE SAME

(71) Applicant: Samsung Electronics Co., Ltd., Gyeonggi-do (KR)

(72) Inventors: Youbi SEO, Gyeonggi-do (KR); Yoonho LEE, Gyeonggi-do (KR); Eunkyung LEE, Gyeonggi-do (KR); Dohee CHUNG, Gyeonggi-do (KR)

(21) Appl. No.: 17/114,960

(22) Filed: Dec. 8, 2020

(30) Foreign Application Priority Data
Dec. 13, 2019 (KR) 10-2019-0166969

(51) Int. Cl. G06F 3/01; G06F 3/038; G06F 3/14; G06K 9/00

(52) U.S. Cl. CPC G06F 3/013; G06F 3/038; G09G 2354/00; G06K 9/00604; G06F 3/1446

(57) ABSTRACT

In accordance with certain embodiments, an information providing device, comprises a display configured to display information; a camera; and a processor operatively connected with the display, and the camera, wherein the processor is configured to: when there is information to output, determining whether a user is gazing at the display using the camera; output the information at a first output speed with respect to a change speed of the information, when it is determined that the user is gazing at the display; and output the information based on a second output speed slower than the first output speed with respect to the change speed of the information, when it is determined that the user is not gazing at the display.

### CROSS-REFERENCE TO RELATED APPLICATION(S)

This application is based on and claims priority under 35 U.S.C. § 119 to Korean Patent Application No. 10-2019-0166969, filed on Dec. 13, 2019, in the Korean Intellectual Property Office, the disclosure of which is incorporated by reference herein its entirety.

### BACKGROUND

### 1. Field

The disclosure relates to an information providing method for adaptively changing an information output form depending on an environment where a user views information provided by an electronic device and an electronic device for supporting the same.

### 2. Description of Related Art

An electronic device can output an image among information for a user on a display device and outputs audio through its speaker. Because such a manner of providing information outputs information based on a static predetermined scheme, various problems may be caused.

The above information is presented as background information only to assist with an understanding of the disclosure. No determination has been made, and no assertion is made, as to whether any of the above might be applicable as prior art with regard to the disclosure.

### SUMMARY

In accordance with certain aspects, an information providing device, comprises a display configured to display information; a camera; and a processor operatively connected with the display, and the camera, wherein the processor is configured to: when there is information to output, determining whether a user is gazing at the display using the camera; output the information at a first output speed with respect to a change speed of the information, when it is determined that the user is gazing at the display; and output the information based on a second output speed slower than the first output speed with respect to the change speed of the information, when it is determined that the user is not gazing at the display.

In accordance with another aspect of the disclosure, an information providing method comprises receiving a user utterance; determining whether a user gazes at a display of an information providing device by capturing an image with a camera; outputting response information corresponding to the user utterance based on a first output speed, when the image indicates the user gazes at the display; and outputting the response information based on a second output speed slower than the first output speed, when the image indicates that the user does not gaze at the display.

Other aspects, advantages, and salient features of the disclosure will become apparent to those skilled in the art from the following detailed description, which, taken in conjunction with the annexed drawings, discloses certain embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a drawing illustrating an example of a providing system associated with operating an information providing function according to an embodiment;

FIG. 2 is a block diagram illustrating an example of a configuration of a user management server device according to an embodiment;

FIG. 3 is a block diagram illustrating an example of a configuration of an information providing device according to an embodiment;

FIG. 4 is a flowchart illustrating an example of an information providing method according to a distance between an information providing device and a user according to an embodiment;

FIG. 5 is a drawing illustrating an example of a screen interface associated with providing information according to a distance between an information providing device and a user according to an embodiment;

FIG. 6 is a drawing illustrating another example of a screen interface associated with providing information according to a distance between an information providing device and a user according to an embodiment;

FIG. 7 is a flowchart illustrating an example of an information providing method according to a viewing state of a user according to an embodiment;

FIG. 8 is a drawing illustrating an example of a screen interface associated with providing information according to a viewing state of a user according to an embodiment;

FIG. 9 is a flowchart illustrating another example of an information providing method according to a viewing state of a user according to an embodiment;

FIG. 10 is a drawing illustrating another example of a screen interface associated with providing information according to a viewing state of a user according to an embodiment;

FIG. 11A is a flowchart illustrating an example of an information providing method according to a user state according to an embodiment;

FIG. 11B is a drawing illustrating an example of a screen interface associated with providing information according to a user state according to an embodiment;

FIG. 12 is a flowchart illustrating another example of an information providing method according to a user state according to an embodiment;

FIG. 13 is a flowchart illustrating another example of an information providing method according to a user state according to an embodiment;

FIG. 14 is a flowchart illustrating an example of an information providing method according to a device characteristic of an information providing device according to an embodiment;

FIG. 15 is a drawing illustrating an example of information adjustment and output according to a characteristic of an information providing device according to an embodiment; and

FIG. 16 is a block diagram illustrating a power management module and a battery of an electronic device according to certain embodiments.

With regard to description of drawings, the same or similar denotations may be used for the same or similar components.

### DETAILED DESCRIPTION

For example, displaying text with a particular font size without regard to have far the user is from the device can result in the text being too small for the user to read. Furthermore, playing back media when the user is not viewing the electronic device results in the user missing the information contained in the media.

Aspects of the disclosure may address at least the above-mentioned problems and/or disadvantages and to provide at least the advantages described below. Accordingly, an aspect of the disclosure may provide an information providing method for enhancing information transmission efficiency by adaptively changing an information output form with regard to a viewing environment of the user and an electronic device for supporting the same.

Furthermore, another aspect of the disclosure may provide an information providing method for enhancing information transmission efficiency by transmitting information based on an information output type or form in the form of being more suitable for the user and an electronic device for supporting the same.

Furthermore, another aspect of the disclosure may provide an information providing method for enhancing information recognition efficiency of the user by adjusting the amount of information to be transmitted or a level of detail (LOD) of the information depending on a user state and an electronic device for supporting the same.

Furthermore, another aspect of the disclosure may provide an information providing method for adaptively providing a guide or a hint associated with using information with regard to a situation where the user uses the electronic device and an electronic device for supporting the same.

The others, other purposes, and effects according to them may be disclosed together with describing certain embodiments in a detailed description of the disclosure.

Hereinafter, certain embodiments of the disclosure may be described with reference to accompanying drawings. However, it should be understood that this is not intended to limit the disclosure to specific implementation forms and includes various modifications, equivalents, and/or alternatives of embodiments of the disclosure.

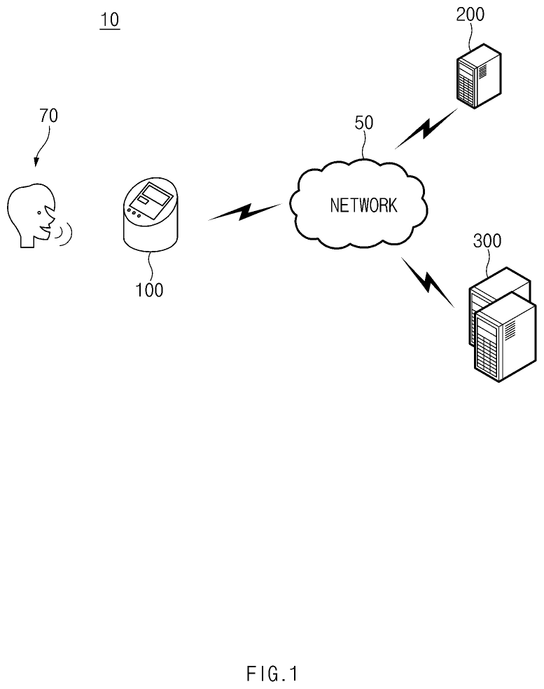

FIG. 1 is a drawing illustrating an example of an information providing system according to an embodiment. A user 70 can utter a request for information to an information providing device 100. The information providing device 100 can forward the user utterance to a user management server 200. The user management server 200 performs voice recognition on the user utterance, such as transferring the user utterance to text. The content server 300 can use the text to collect the information sought by the user and return the information to the information providing device 100.

The information providing device 100 determines whether the user is gazing at the display and how far the user is from the information providing device 100. Based on the foregoing, the information providing device 100 adjusts the manner that the information is output to the user, including using a display or speaker, the volume if the speaker is chosen, the size that the information is output on the display if the output is chosen, and whether the use another electronic device such as a paired watch or earphone.

Referring to FIG. 1, an information providing system 10 according to an embodiment may include an information providing device 100, a user management server 200 (or user management server device 200), a content server 300 (or a content server device 300), a network 50 (such as the internet). The information providing system 10 can provide information to a user 70.

The user 70 may receive information via the information providing device 100 (e.g., an artificial intelligence (AI) speaker device, a portable electronic device, or a smartphone). In this process, the user 70 may make an utterance requesting an information search using a microphone included in the information providing device 100. The information providing device 100 use speech recognition to understand the user's utterance and retrieve information from the content server 300. According to certain embodiments, the information providing device 100 may transmit the user utterance to the user management server 200, and the user management server 200 may perform speech recognition of the user's utterance, collect information about the recognized result, and transmit the collected information to the information providing device 100.

The network 50 may support to establish at least one of a communication channel between the content server 300 and the information providing device 100, a communication channel between the content server 300 and the user management server 200, or a communication channel between the user management server 200 and the information providing device 100. The network 50 may support at least one scheme capable of supporting a communication scheme of the information providing device 100. For example, the network 50 may support communication schemes of various generations, such as 3rd generation (3G), 4th generation (4G), and 5th generation (5G), and may support a wired or wireless communication scheme. In certain embodiments, the network 50 can include the internet or the internet and a combination of other networks.

The content server 300 may provide certain information to a device accessed over the network 50. According to an embodiment, the content server 300 may receive a query message from the information providing device 100 or the user management server 200 and may provide the information providing device 100 or the user management server device 200 with a response message corresponding to the query message. The content server 300 may store and manage a variety of information, for example, weather information, financial information, entertainment information, and news, and may provide accessed devices with a message including the information. The above-mentioned content server 300 may configure a specific form of information or a specific type of information depending on a request of the user management server device 200 or a characteristic of an output device of the information providing device 100 and may provide the information providing device 100 with the information (e.g., information including at least one of a text, an image, or an audio).

The user management server 200 may establish a communication channel with the information providing device 100 over the network 50. The user management server 200 may receive a user utterance or information obtained by performing speech recognition of the user utterance as recognition information from the information providing device 100. When receiving a user utterance from the information providing device 100, the user management server 200 may perform speech recognition of the user utterance, analyze the recognized result, and collect a response to the analyzed result. The response may include at least one of a text, an audio, a video, or an image to be provided to the information providing device 100. When needing information stored in the content server 300 in configuring the response, the user management server 200 may access the content server 300 to collect the information necessary to configure the response. According to an embodiment, the user management server 200 may receive the utterance, “What's the weather like today?”, or the result of performing the speech recognition of the utterance from the information providing device 100. The user management server 200 may access the content server 300 which provides weather information, may collect the weather information from the content server 300, and may provide the information providing device 100 with the collected weather information. In this process, the user management server 200 may determine whether the user 70 is gazing (or otherwise staring at the information providing device 100 to be observing the display), e.g., identify information about a gaze state (or a stare state) of the user 70 or a distance between the user 70 and the information providing device 100 from the information providing device 100. Based on whether the user is gazing and the distance between the user and the information providing device 100 adjust at least the size of information to be provided to the information providing device 100, an information output method (using the display or a speaker), or using a different information output device. The user management server 200 may transmit the adjusted information to the information providing device 100. According to certain embodiments, the user management server 200 may include an AI server which provides specific information to the information providing 100 in response to a user voice or processes a voice command capable of running a specific application of the information providing device 100.

The information providing device 100 may collect a user utterance. The information providing device 100 may include at least one of, for example, an AI speaker, a smartphone, a tablet personal computer (PC), a wearable electronic device, or a desktop electronic device. According to certain embodiments, the information providing device 100 may be a device including at least one output device (e.g., at least one of a display or a speaker) capable of outputting information. The information providing device 100 may output information to the user through its output device (e.g., at least one of the display or the speaker). The information providing device 100 may determine a viewing state or a viewing environment of the user based on a sensor(s). Based on the viewing state or viewing environment, the information providing device 100 may change at least one of the format that the information is output, the information output device, or an information output method.

In conjunction with the information output form, the information providing device 100 may use, for example, the same means (e.g., the display or the speaker) for outputting information, with adjustments for the amount of information to be output, a level of detail (LOD) of the information, a size at which the information is displayed, or an audio level at which the information is output. In conjunction with the information output device, the information providing device 100 may establish a communication channel with a specified electronic device (such as a Bluetooth paired headphone or smartwatch) and may output information via the specified electronic device. In this operation, the information providing device 100 may process information to suit a physical specification (e.g., a size or resolution of a display, or a channel or audio output performance of a speaker) of an information output means (e.g., the display or the speaker) of the specified electronic device and may output the processed information via the specified electronic device. According to certain embodiments, in conjunction with the information output method, the information providing device 100 may output information using at least one of means (e.g., the display or the speaker) which outputs information depending on a viewing state or a viewing environment of the user.

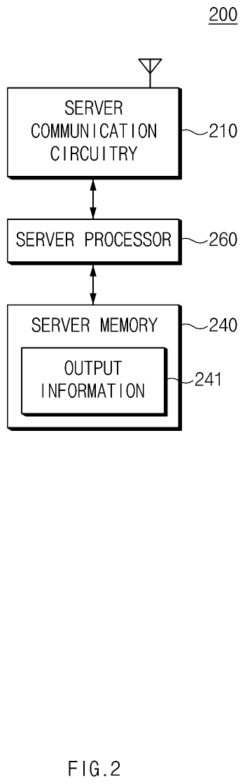

FIG. 2 is a block diagram illustrating an example of a configuration of a user management server 200 according to an embodiment.

Referring to FIG. 2, a user management server 200 (or a user management server device 200) according to an embodiment may include a server communication circuitry 210, a server processor 260, and a server memory 240.

The server communication circuitry 210 may establish a communication channel of the user management server 200. For example, the server communication circuitry 210 may establish a communication channel with a network 50 of FIG. 1 in at least one of a wired scheme or a wireless scheme and may establish a communication channel with an information providing device 100 accessed over the network 50. The server communication circuitry 210 may receive at least one of a user utterance or the result of performing speech recognition of the user utterance and may provide the server processor 260 with it. The server communication circuitry 210 may provide the information providing device 100 with information corresponding to the result of performing the speech recognition based on the user utterance in response to control of the server processor 260.

The server memory 240 may store a variety of information associated with operating the user management server 200. For example, the server memory 240 may store a speech recognition application capable of performing speech recognition of an utterance received from the information providing device 100 and a database for speech recognition. The server memory 240 may include an analysis algorithm for analyzing the result of performing the speech recognition and output information 241 to be provided to the information providing device 100 in response to the analyzed result. The output information 241 may include information received from a content server device 300 of FIG. 1.

The server processor 260 may process or deliver various signals associated with operating the user management server 200. For example, the server processor 260 may establish a communication channel in response to a request of the information providing device 100 and may provide the information providing device 100 with a specified screen or page. When receiving a user utterance from the information providing device 100, the server processor 260 may perform speech recognition of the user utterance based on the speech recognition application stored in the server memory 240. Alternatively, the server processor 260 may receive the result of performing the speech recognition from the information providing device 100 and may analyze the received result of performing the speech recognition.

The server processor 260 may provide the information providing device 100 with the output information 241 based on the analysis of the speech recognition. In this operation, the server processor 260 may adjust at least a portion of the output information 241 based on additional information (e.g., a distance between a user and the information providing device 100 or information indicating whether the user is gazing at the information providing device 100) received from the information providing device 100. The server processor 260 may provide the information providing device 100 with the adjusted output information. The server processor 260 may receive a characteristic of an output device of the information providing device 100 and may configure the output information 241 as at least one of screen information or audio information depending on the received characteristic of the output device (e.g., a size of the display, resolution of the display, setting volume of the speaker, performance of the speaker, or settings of the earphone) and may transmit the configured information to the information providing device 100. Alternatively, the server processor 260 may provide the information providing device 100 with information obtained by adjusting at least one of a screen size or a volume level of the output information 241 to be output based on personal information (e.g., age information, eyesight information or hearing information) who is viewing the information providing device 100, the amount or a level of detail (LOD) of data configuring a screen, a layout of the screen, or volume setting information of the speaker or the earphone.

Meanwhile, according to certain embodiments, when an information output function of the disclosure is performed by the information providing device 100, the configuration of the user management server device 200 may be omitted.

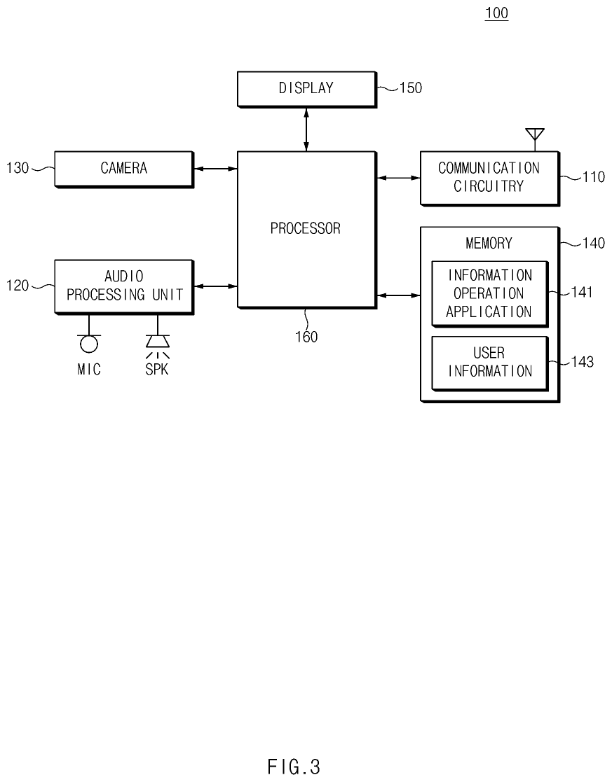

FIG. 3 is a block diagram illustrating an example of a configuration of an information providing device according to an embodiment. The information providing device 100 includes a microphone MIC which can receive a user utterance. In certain embodiments, the information providing device 100 can include a display 150 that is a touchscreen display. The user can enter inputs with the touch screen display. The information providing device 100 can also output information using the display 150 or using a speaker SPK. The information providing device 100 includes a camera 130 which can determine a gazing state and distance of a user, by examining an image from the vantage point of the camera 130. Based on the foregoing, the information processing device 100 can select whether to output using the speaker SPK or display 150, or another electronic device, and adjust other parameters.

Referring to FIG. 3, an information providing device 100 according to an embodiment may include a communication circuitry 110, an audio processing unit 120, a camera 130, a memory 140, a display 150, and a processor 160. According to certain embodiments, the information providing device 100 may further include at least one sensor for determining a distance from a user.

The communication circuitry 110 may support a communication function of the information providing device 100. The communication circuitry 110 may include at least one communication module, which can include modulators, demodulators, transceivers, and antennas. For example, the communication circuitry 110 may include at least one long-range wireless communication circuitry to support to establish a communication channel through a 3G, 4G, or 5G base station. According to certain embodiments, the communication circuitry 110 may include at least one short-range wireless communication circuitry (such as Bluetooth) or at least one wired communication circuitry to establish a communication channel with another electronic device located adjacent to the information providing device 100. In response to control of the processor 160, the communication circuitry 110 may provide at least one of a user management server device 200 or a content server device 300 of FIG. 1 with a user utterance or the result of performing speech recognition of the user utterance and may receive a response (e.g., output information 241 of FIG. 2) corresponding to the user utterance from the user management server device 200 or the content server device 300. According to certain embodiments, the communication circuitry 110 may provide at least one of the user management server 200 or the content server 300 with information about at least one of a gaze state of a user or a distance from the user.

The audio processing unit 120 may perform audio processing of the information providing device 100. In this regard, the audio processing unit 120 may include at least one speaker SPK or at least one microphone MIC. Additionally or alternatively, the audio processing unit 120 may further include at least one wired earphone or at least one wireless earphone. The microphone MIC of the audio processing unit 120 may always remain turned on in response to control of the processor 160 and may have an idle state capable of receiving a user utterance. Alternatively, the microphone MIC may have an idle state capable of receiving a user utterance when the display 150 is touched or when a specific user input occurs. The speaker SPK of the audio processing unit 120 may output a response corresponding to the user utterance as an audio signal. The response corresponding to the user utterance may include at least one of information received from the user management server device 200 or the content server device 300 or information previously stored in the memory 140.

The camera 130 may capture an image of a specific direction. According to an embodiment, the camera 130 may be located toward the same direction as a direction where the display 150 is disposed. Alternatively, the camera 130 may be disposed at one side of a housing covering the display 150, which may be located in the same direction as a direction where it is able to observe the display 150. When a user utterance occurs, the camera 130 may be turned on under control of the processor 160 to automatically capture an image of a specified direction and provide the processor 160 with the captured image. In this operation, the processor 160 may output a guide or preview screen for image capture by the camera 130, an image capture screen, or the like on the display 150 or may guide a user through the guide or preview screen, the image capture screen, or the like by means of the speaker SPK.

The memory 140 may store data or an application associated with operating the information providing device 100. According to an embodiment, the memory 140 may store an information operation application 141. The information operation application 141 may include, for example, a routine of collecting information about a user utterance, a routine of performing speech recognition of the user utterance, a routine of extracting the result (e.g., text) of performing the speech recognition, a routine of retrieving response information (e.g., the output information or content information) based on the result of performing the speech recognition, or a routine of outputting the retrieved response information through an output device (e.g., the display 150 and the speaker SPK). According to certain embodiments, the memory 140 may store user information 143. Alternatively, the user information 143 may include, for example, personal information (e.g., an age, a visual state, or an audible state) of the user who uses the information providing device 100 and user classification information (e.g., voiceprint-based user classification information or face-based user classification information).

The display 150 may output at least one screen associated with operating the information providing device 100. According to an embodiment, the display 150 may output a screen associated with operating the information providing device 100. For example, the display 150 may display a screen associated with collecting a user utterance, a screen notifying the user of the result of performing speech recognition of the user utterance, or a screen associated with a response corresponding to the result of performing the speech recognition. In this operation, the display 150 may output at least a portion of the output information 241 or adjusted information obtained by adjusting the output information 241, in response to control of the processor 160.

According to certain embodiments, the information providing device 100 may include a housing. A groove or a hole may be formed at one side of the housing. The display 150 may be received in the groove, or at least a part of the display 150 may be exposed to the outside (or be observed from the outside) through the hole. Furthermore, a speaker hole and a microphone hole may be formed at one side of the housing. The audio processing unit 120 may be disposed an inner side of the housing, which may output audio information through the speaker hole and may collect a user utterance through the microphone hole.

The processor 160 may deliver and process a signal associated with operating the information providing device 100. For example, the processor 160 may turn on the microphone MIC or may keep the microphone MIC turned on to receive a user utterance. The processor 160 may transmit the received user utterance or the result of performing the speech recognition of the user utterance to the user management server device 200 and may receive a response (e.g., the output information 241) from the user management server device 200. According to certain embodiments, the processor 160 may provide the content server device 300 with the result of performing the speech recognition of the user utterance and may receive a response from the content server device 300. The processor 160 may output the received response via the output device. In this operation, the processor 160 may measure a distance from the user using the camera 130 or at least one sensor. According to an embodiment, the processor 160 may determine a gaze state of the user (e.g., whether the user gazes at the display 150 or a display located on the same surface as a surface where the camera 130 is disposed) using the camera 130. The processor 160 may provide the user management server device 200 or the content server device 300 with information about at least one of a distance from the user or a gaze state of the user and may receive adjusted output information corresponding to the information.

According to certain embodiments, when it is required to output specific information, the processor 160 of the information providing device 100 may retrieve the information previously stored in the memory 140 and may output the retrieved information through the output device (e.g., the display 150 or the speaker SPK). In this operation, the processor 160 may identify at least one of a distance from the user or a gaze state of the user using at least one of the camera 130 or the sensor and may adjust information to be output or may output the information without separate adjustment, depending on the identified result.

According to certain embodiments, when the distance from the user is less than a specified distance, the processor 160 may form a screen on the basis of a first font size and may output the screen formed with the first font size on the display 150. When the distance from the user is greater than or equal to the specified distance, the processor 160 may form a screen using a second font size greater than the first font size and may output the screen formed with the second font size on the display 150.

According to certain embodiments, when the distance from the user is less than the specified distance, the processor 160 may form and output a screen of the display 150 using the amount of data of a first size. When the distance from the user is greater than or equal to the specified distance, the processor 160 may form and output a screen of the display 150 using the amount of data of a second size smaller than the first size. Herein, the screen formed with the amount of the data of the second size may include the same contents as the screen formed with the first size, which may output an image more enlarged than the screen formed with the first size.

According to certain embodiments, when the distance from the user is less than the specified distance, the processor 160 may output a screen having a level of detail (LOD) of data of the first size on the display 150. When the distance from the user is greater than or equal to the specified distance, the processor 160 may output a screen having an LOD of data of the second size smaller than the first size on the display 150. Herein, a first LOD may include the same category or the same type of content as a second LOD, but may refer to a content state where at least one of a description, tag information, or an annotation is smaller than the second LOD.

According to certain embodiments, the processor 160 may adjust a degree to which the output screen is divided, depending on a distance from the user. For example, when the distance from the user is less than the specified distance, the processor 160 may perform relatively many screen splits and may output specified information (e.g., response information corresponding to a user utterance) on each of the split screens. When the distance from the user is greater than or equal to the specified distance, the processor 160 may perform relatively few screen splits and may output specified information (e.g., response information corresponding to a user utterance) on the split screens or one screen (a full screen) without a separate split.

According to certain embodiments, the processor 160 may adjust a brightness or color of the output screen depending on a distance from the user. For example, when the distance from the user is less than the specified distance, the processor 160 may output a content screen including a relatively low brightness or a relatively dark color. When the distance from the user is greater than or equal to the specified distance, the processor 160 may output a content screen which includes the same content as content output in the state where the distance from the user is less than the specified distance, but includes a relatively high brightness or a relatively bright color to enhance an information recognition rate.

According to certain embodiments, the processor 160 may differently control a type of an output device which will output information, depending on whether the user gazes at the display 150 (or the camera 130). For example, when the user gazes at the display 150, the processor 160 may configure information to be output (e.g., response information corresponding to a user utterance) in the form of including at least a portion of a text and an image and may output the information on the display 150. When the user does not gaze at the display 150, the processor 160 may convert information to be output into audio information (e.g., text to sound (TTS)) and may output the converted audio information through the speaker SPK (or an earphone when the earphone is connected to the information providing device 100).

According to certain embodiments, the processor 160 may differently control an information output speed depending on whether the user gazes at the display 150 (or the camera 130). For example, when the user gazes at the display 150, the processor 160 may output information to be output (e.g., response information corresponding to a user utterance) at a first playback speed. When the user does not gaze at the display 150, the processor 160 may convert information to be output into audio information (e.g., text to sound (TTS)) and may output the converted audio information through the speaker SPK (or the earphone when the earphone is connected to the information providing device 100).

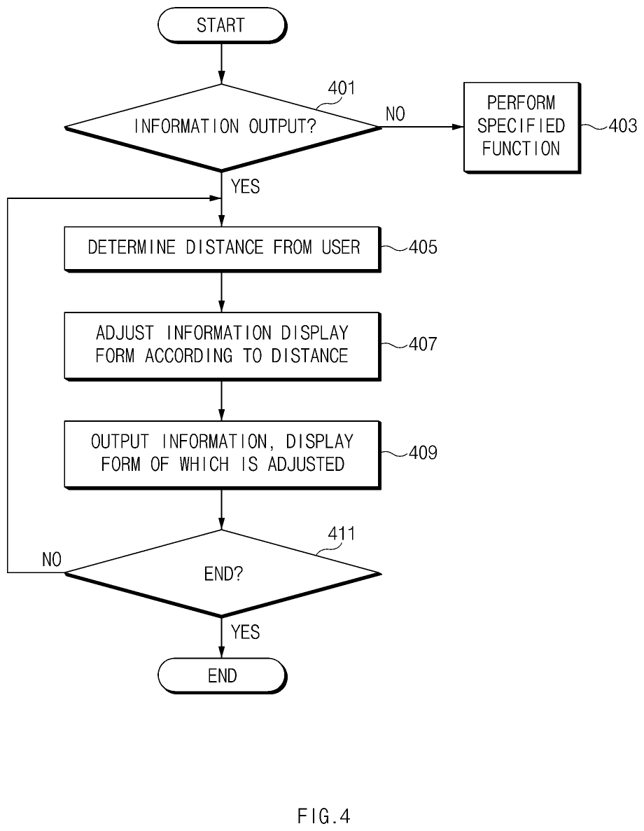

FIG. 4 is a flowchart illustrating an example of an information providing method according to a distance between an information providing device and a user according to an embodiment.

Referring to FIG. 4, in conjunction with the information providing method, in operation 401, when a specified event occurs, a processor 160 of FIG. 3 may identify whether the event is an event requesting to output information. For example, the processor 160 may identify whether a user utterance requesting to output a specific response occurs. Alternatively, the processor 160 may identify whether a user input or a user utterance requesting to retrieve specific information is received. In this regard, the processor 160 of an information providing device 100 may keep a microphone MIC of FIG. 3 turned on or may output an input window for inputting information on a display 150 of FIG. 3. When the event is not the event requesting to output information, in operation 403, the processor 160 may perform a specified function according to an event type. For example, when an event associated with a music playback function or a call function occurs, the processor 160 may run an application associated with the function to play music or make a call.

When the event is the event requesting to output the information, in operation 405, the processor 160 may determine a distance from the user. In this regard, the processor 160 may enable a camera 130 of FIG. 3 or a sensor for distance measurement. The processor 160 may obtain a face image of the user and may estimate a distance from the user on the basis of a size of the face image. In this regard, a memory 140 of the information providing device 100 may previously store reference information about a distance according to a face size of the user. The processor 160 may enable a distance sensor (e.g., an infrared sensor) to measure a distance from the user.

In operation 407, the processor 160 may adjust an information display form according to the distance. In operation 409, the processor 160 may output the information, the display form of which is adjusted. For example, when the distance from the user is less than a specified distance, the processor 160 may set an LOD of the information to be relatively high to display more information on one screen. Alternatively, when the distance from the user is less than the specified distance, the processor 160 may set information to be displayed to be relatively small in size to display more information on one screen. Alternatively, when the distance from the user is greater than or equal to the specified distance, the processor 160 may set an LOD of the information to be relatively low to display less information at a larger size on one screen.

In operation 411, the processor 160 may identify whether an event associated with ending the information output function occurs. When the event associated with ending the information output function does not occur, the processor 160 may branch to operation 405 to perform the operation again from operation 405. Alternatively, the processor 160 may maintain previous operation 409. When the event associated with ending the information output function occurs, for example, when an input signal associated with being powered off is received, when an input signal requesting to end an application associated with outputting corresponding information is received, or when a specified time elapses, the processor 160 may end the information output function and may change to a specified state (e.g., a sleep state or a state immediately before the information output function is performed).

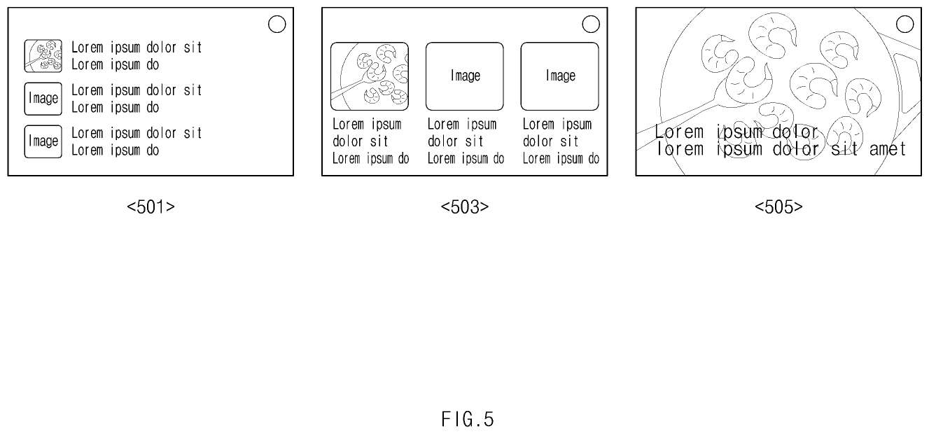

FIG. 5 is a drawing illustrating an example of a screen interface associated with providing information according to a distance between an information providing device and a user according to an embodiment.

Referring to FIG. 5, when a distance from a user is within a first range, a processor 160 of an information providing device 100 of FIG. 3 may output a screen in state 501 on a display 150 of FIG. 3. For example, the processor 160 may output a screen including relatively small images, such as thumbnails, and relatively greater amounts of texts on the display 150.

When the distance from the user is within a second range farther than the first range, the processor 160 may output a screen in state 503 on the display 150. For example, the processor 160 may output a screen including relatively larger images and relatively less amounts of text than the screen in state 501 on the display 150.

When the distance from the user is within a third range farther than the second range, the processor 160 of the information providing device 100 may output a screen in state 505 on the display 150. For example, while outputting a specific one image as the entire screen, the processor 160 may output a screen including at least a portion of a text associated with the image on the display 150.

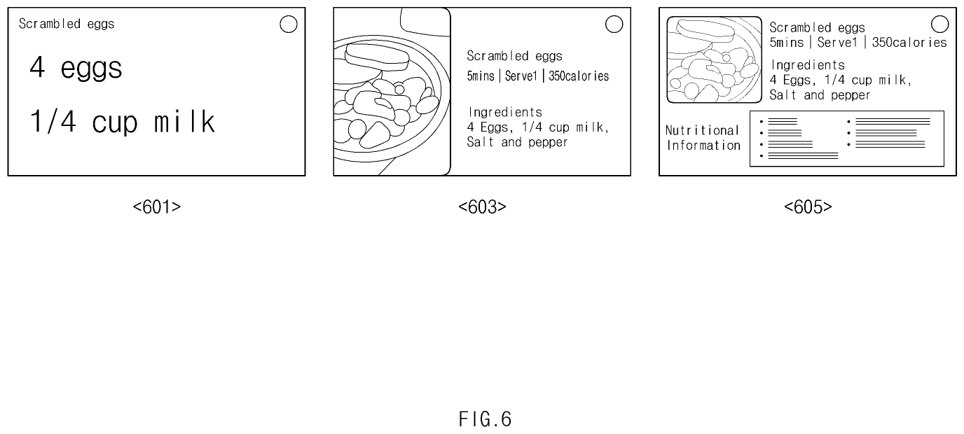

FIG. 6 is a drawing illustrating another example of a screen interface associated with providing information according to a distance between an information providing device and a user according to an embodiment.

Referring to FIG. 6, when a distance from a user is out of a first range, in state 601, a processor 160 of an information providing device 100 of FIG. 3 may output a screen including a text having a first font size, which is relatively large.

When the distance from the user is within the first range (or when the user is closer to the information providing device 100 than that in state 601), in state 603, the processor 160 may output a screen including a text having a second font size smaller than the first font. In this process, the processor 160 may output an image associated with the text together.

When the distance from the user is within the first range (or when the user is closer to the information providing device 100 than that in state 603), in state 605, the processor 160 may output a screen including a text having a third font size smaller than the second font size. In this process, the processor 160 may output an image associated with the text together. The image output in state 605 may be displayed at a size smaller than the image output in state 603.

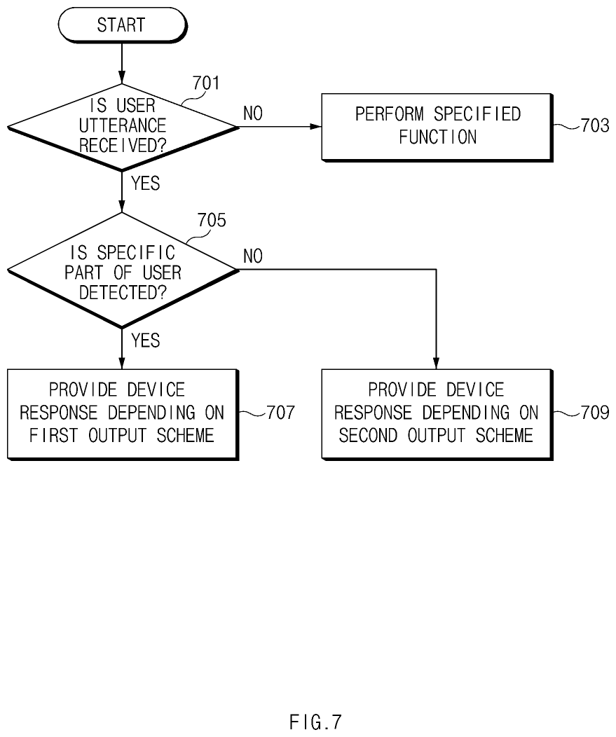

FIG. 7 is a flowchart illustrating an example of an information providing method according to a viewing state of a user according to an embodiment.

Referring to FIG. 7, in conjunction with an information providing method of an information providing device 100 according to an embodiment, in operation 701, a processor 160 of the information providing device 100 may identify whether a user utterance is received. In this regard, the processor 160 may keep a microphone MIC of FIG. 3 turned on to receive a user utterance. According to certain embodiments, the information providing device 100 may enable at least one of a plurality of microphones, and may enable the plurality of microphones when an utterance (e.g., “Hi bixby”) corresponding to a wake-up message is received to receive a user utterance. In this operation, when the user utterance is not received, in operation 703, the processor 160 may perform a specified function. For example, the processor 160 may switch a display 150 of FIG. 3 to a turn-off state and may shift to a sleep state. Alternatively, the processor 160 may output a screen according to performing a specific function according to a user input on the display 150.

When the user utterance is received, in operation 705, the processor 160 may identify whether a specific part of the user's body is detected. In this process, the processor 160 may perform speech recognition of the user utterance with background processing. For example, the processor 160 may receive a response (or output information) corresponding to the result of performing the speech recognition from a user management server device 200 or a content server device 300 of FIG. 1. When the user utterance is received, the processor 160 may enable a camera 130 of FIG. 3 to capture an image of a set direction using the enabled camera 130. The processor may analyze the captured image to identify whether an image for a predefined specific part of the user is detected. The specific part of the user may include at least one of, for example, the head or face of the user, the periphery of eyes of the user, or the pupils of the user.

When the specific part of the user is detected, in operation 707, the processor 160 may provide a device response depending on a first output scheme. For example, detection of a specific part of the user can indicate that the user is either gazing or within a certain distance. In certain embodiments, the processor 160 may configure an output in response to a user utterance as an image to be provided on the display 150.

When the specific part of the user is not detected, in operation 709, the processor 160 may provide a device response depending on a second output scheme. For example, the processor 160 may configure the output as audio information output through a speaker SPK of FIG. 3.

In the above-mentioned operations, the processor 160 may request the user management server device 200 or the content server device 300 to transmit a type of information to be output (e.g., a screen or an audio), depending on whether the specific part of the user is detected, and may receive a response of the type from the user management server device 200 or the content server device 300. Alternatively, the processor 160 may receive both of a response to be output as a screen and a response to be output as an audio from the user management server device 200 or the content server device 300 and may selectively output a device response in the first output scheme or the second output scheme depending on whether the specific part of the user is detected. In the above-mentioned operations, the processor 160 may detect a response corresponding to whether the specific part of the user is detected from information previously stored in a memory 140 of FIG. 3 and may output the detected response.

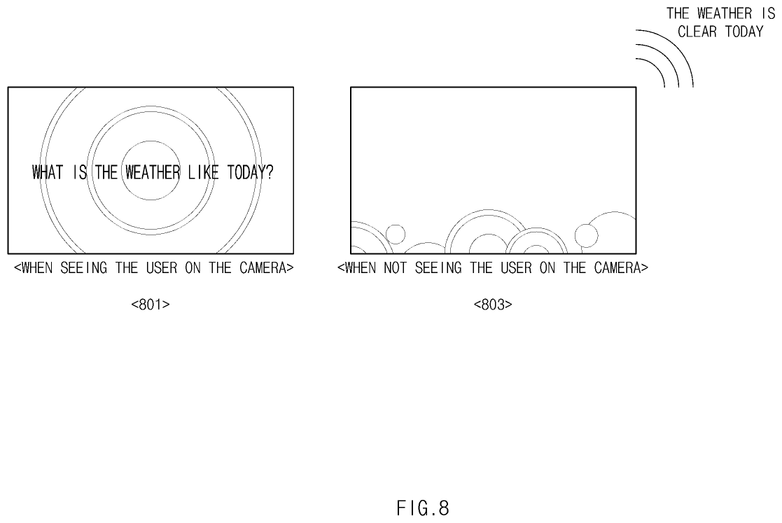

FIG. 8 is a drawing illustrating an example of a screen interface associated with providing information according to a viewing state of a user according to an embodiment.

Referring to FIG. 8, when a user utterance is received, a processor 160 of an information providing device 100 of FIG. 3 may enable a camera 130 of FIG. 3 to capture an image. When a specific part of a user (e.g., a face of the user) is detected from the captured image, in state 801, the processor 160 may output a response according to a first output scheme. For example, the processor 160 may output recognition information obtained by recognizing the user utterance on a display 150 of FIG. 3. Furthermore, the processor 160 may output response information to the user utterance on the display 150.

According to certain embodiments, when the specific part of the user (e.g., the face of the user) is not detected from the captured image, in state 803, the processor 160 of the information providing device 100 may output information according to a second output scheme. For example, the processor 160 may output the recognition information obtained by recognizing the user utterance or the response information to the user utterance through a speaker SPK of FIG. 3.

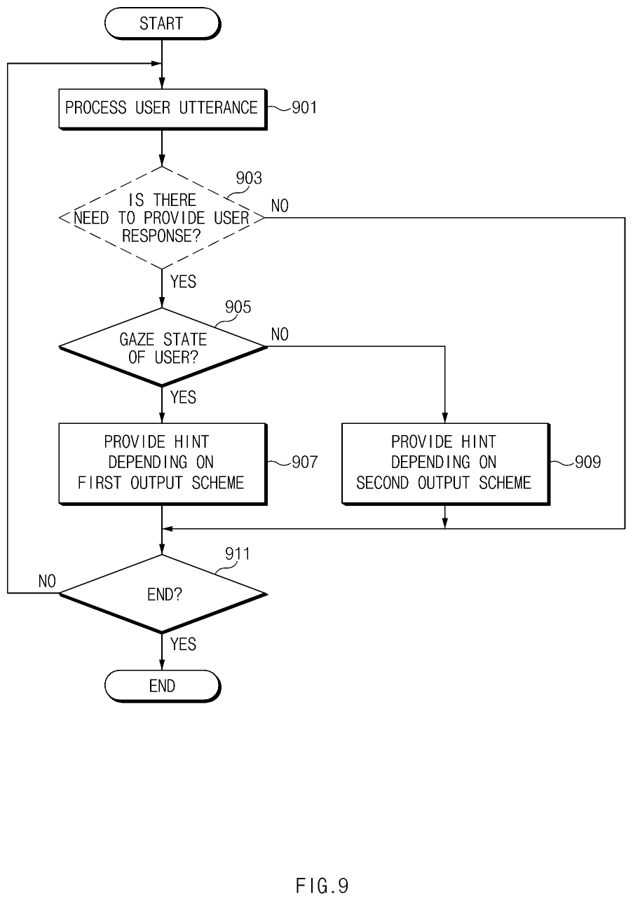

FIG. 9 is a flowchart illustrating another example of an information providing method according to a viewing state of a user according to an embodiment.

Referring to FIG. 9, in conjunction with the information providing method according to an embodiment, in operation 901, a processor 160 of an information providing device 100 of FIG. 3 may process a user utterance. In this regard, the processor 160 may enable a microphone MIC of FIG. 3 or may always keep the microphone MIC turned on to collect a user utterance. When the user utterance is collected, the processor 160 may perform speech recognition of the user utterance using a speech recognition application installed in the information providing device 100 or may perform processing (e.g., speech recognition) for the user utterance based on a speech recognition function provided by a user management server 200 of FIG. 1.

In operation 903, the processor 160 may identify whether there is a need to provide a user response, as a result of processing the user utterance. According to an embodiment, the processor 160 may determine whether to retrieve a user response to the user utterance and output the retrieved result, as a result of performing the speech recognition of the user utterance. For example, the processor 160 may identify whether the user utterance includes verbal contents requesting to retrieve specific information or whether the user utterance requests to execute a specific function and includes verbal contents needing a response to the request. According to certain embodiments, the operation of identifying whether there is the need to provide the user response may be omitted.

When there is the need to provide the user response, in operation 905, the processor 160 may identify a gaze state of the user. In this regard, the processor 160 may enable a camera 130 of FIG. 3 to capture an image of a specified direction and may identify whether a gaze of the user is toward the information providing device 100. When the gaze state of the user is toward the information providing device 100, in operation 907, the processor 160 may provide a hint depending on a first output scheme. For example, the processor 160 may output at least one of guidance information about a function capable of being performed by the user, a hint written based on a search history where the user previously performs a search, or a hint written based on a function execution history of being previously executed on a display 150 of FIG. 3. Alternatively, the processor 160 may output a screen, including at least one of a text or an image, as a hint on the display 150.

When the gaze state of the user is not toward the information providing device 100, in operation 909, the processor 160 may provide a hint depending on a second output scheme. For example, the processor 160 may convert a hint to be output into audio information and may output the converted audio information through a speaker SPK of FIG. 3.

In operation 911, the processor 160 may identify whether an event associated with ending the information providing function for the user utterance occurs. When the event associated with ending the information output function does not occur, the processor 160 may branch to operation 901 to perform the operation again from operation 901. Alternatively, when the event associated with ending the information output function does not occur, the processor 160 may maintain a previous state, for example, the state in operation 907 or 909. Meanwhile, when there is no need to provide the user response in operation 903, the processor 160 may branch to operation 911.

In the above-mentioned description, the contents of determining the gaze state of the user depending on whether there is the need to provide the user response is described, but the disclosure is not limited thereto. For example, irrespective of whether there is the need to provide the user response, when the user utterance is received in operation 901, the processor 160 of the information providing device 100 may identify a gaze state of the user in operation 905 and may perform any one of operation 907 or operation 909 depending on whether the user gazes at the information providing device 100.

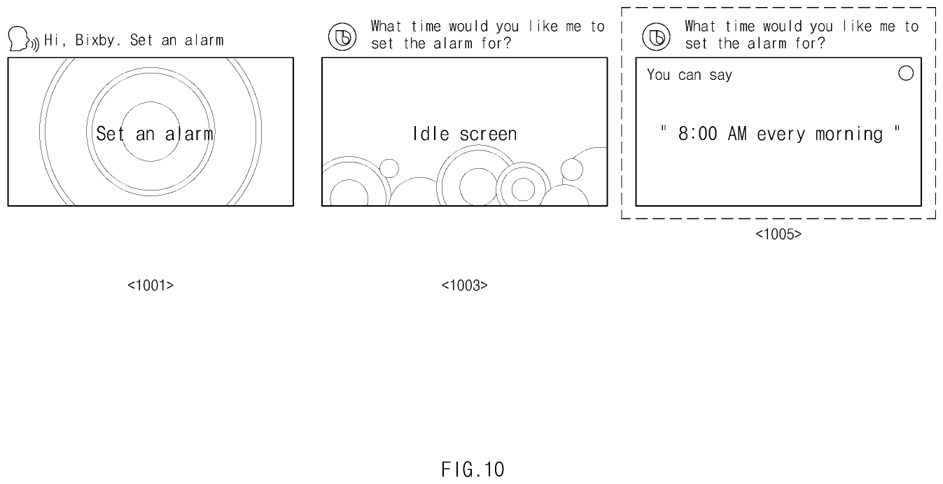

FIG. 10 is a drawing illustrating another example of a screen interface associated with providing information depending on a viewing state of a user according to an embodiment.

Referring to FIG. 10, when a user utterance is received, a processor 160 may perform speech recognition of the user utterance, analyze the recognized contents, and enable a function according to the analyzed contents. The processor 160 may output a screen corresponding to enabling the function according to the analyzed contents on a display in state 1001. In this operation, the processor 160 may turn on a microphone MIC or may keep the microphone MIC turned on. The processor 160 may output a response according to the collection of the user utterance in state 1003. When outputting the user response corresponding to the user utterance, the processor 160 may maintain a specified screen state (e.g., a state where an idle screen is displayed).

When a predetermined time elapses without an additional user utterance after outputting the specified screen state, the processor 160 may provide a hint in state 1005. The hint may include a text or an image guiding the user to provide a user utterance.

According to certain embodiments, the processor 160 may identify whether the user gazes at the information providing device 100 and may change a scheme of outputting a hint, depending on whether the user gazes at the information providing device 100. For example, when the user utterance is received in state 1001, the processor 160 may identify whether the user gazes at the information providing device 100. The information providing device 100 may output a response to the user utterance through a speaker SPK of FIG. 3 while maintaining a specified screen state in state 1003, when the user does not gaze at the information providing device 100. When the user gazes at the information providing device 100, the processor 160 may output a response to the user utterance through the display 150 and the speaker SPK in state 1005.

According to certain embodiments, the processor 160 may identify whether the user gazes at the display 150 of the information providing device 100 and may output a response corresponding to the user utterance through the speaker SPK, while outputting a specified screen in state 1003, when the user does not gaze at the display 150. Thereafter, when there is no additional user utterance during a specified time, the processor 160 may output a hint through the display 150 and the speaker SPK in state 1005.

According to certain embodiments, after outputting the specified screen (e.g., an idle screen), when a current state changes to the gaze state of the user, in state 1005, the processor 160 may output a hint on the display 150. In conjunction with determining the gaze state of the user, the processor 160 may enable the camera 130 located in the same direction as a direction where the display 150 is disposed to obtain an image for the periphery of eyes of the user and may determine where the gaze of the user is heading, based on location analysis or location tracking of eyes or pupils of the user.

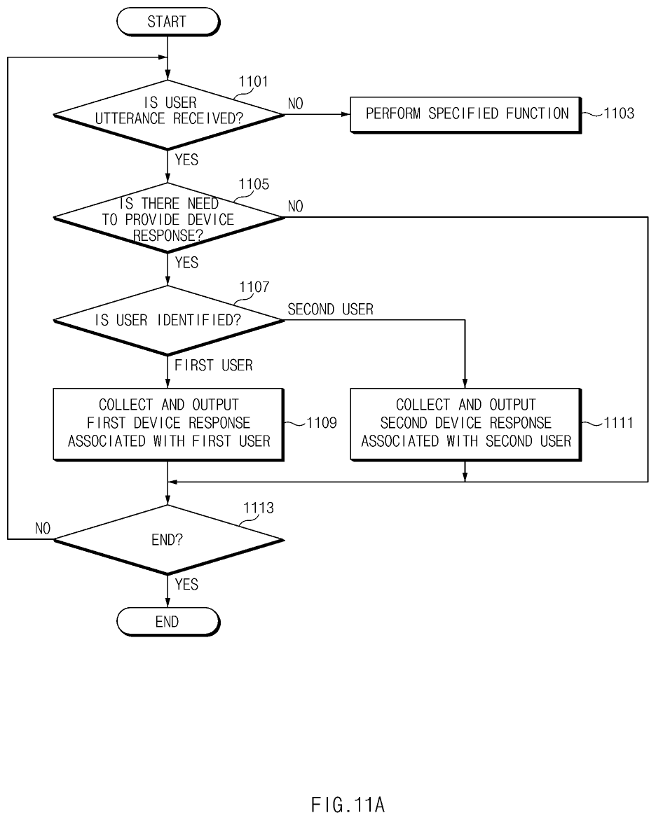

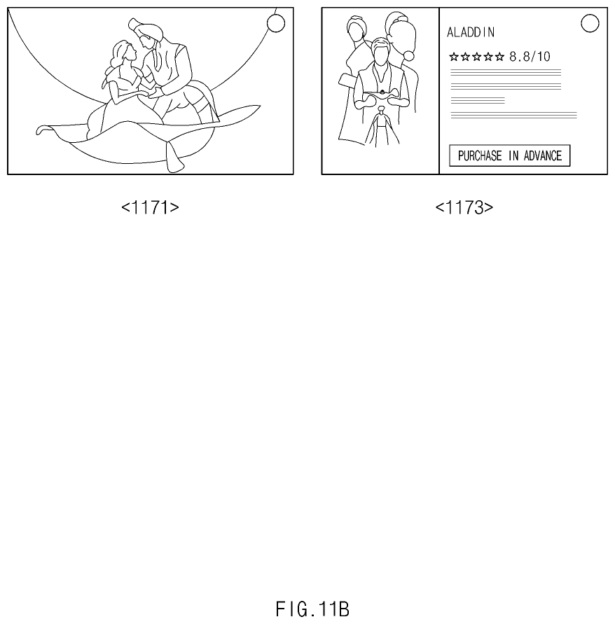

FIG. 11A is a flowchart illustrating an example of an information providing method according to a user state according to an embodiment.

Referring to FIG. 11A, in conjunction with the information providing method, in operation 1101, a processor 160 of an information providing device 100 of FIG. 3 may identify whether a user utterance is received. When the user utterance is not received, in operation 1103, the processor 160 may perform a specified function. For example, the processor 160 may keep a microphone MIC of FIG. 3 turned on to wait for receiving a user utterance. In this operation, the processor 160 may turn off a display 150 of FIG. 3.

When the user utterance is received, in operation 1105, the processor 160 may determine whether there is a need to provide a device response. In this regard, the processor 160 may perform speech recognition of the user utterance, may analyze the recognized contents, and may identify whether the user utterance is a query needing a response depending on the analyzed contents. When the user utterance is the query needing the response, in operation 1107, the processor 160 may identify the user. For example, the processor 160 may enable a camera 130 of FIG. 3 to capture a face of the user, may analyze the captured face, and may identify whether the user is any of previously stored specific users. Alternatively, the processor 160 may identify whether the user is a user in any age group through face analysis. Alternatively, the processor 160 may identify a gender of the user through facial analysis.

When the user is a first user in operation 1107, in operation 1109, the processor 160 may collect a first device response associated with the first user and may output the collected first device response. For example, when the first user is a child (or an elderly person) in a relatively younger age group than a second user, the processor 160 may provide outputs that are more image based, as well as filtered to avoid excessively mature content. In this operation, the processor 160 may collect relatively less text information or may output audio information corresponding to the text information.

When the user is the second user in operation 1107, in operation 1111, the processor 160 may collect the second response associated with the second user and may output the collected second response. For example, when the second user is a young person in a relatively higher age group than the first user, the processor 160 may form and output a screen which includes a relatively smaller image than the first device response and includes relatively more texts than the first response.

In operation 1113, the processor 160 may identify whether an event associated with ending the information providing function occurs. When the event associated with ending the information providing function does not occur, the processor 160 may branch to operation 1101 to perform the operation again from operation 1101. Alternatively, the processor 160 may maintain the state before operation 1109 or 1111 during a specified time or until an additional user input occurs.

FIG. 11B is a drawing illustrating an example of a screen interface associated with providing information according to a user state according to an embodiment.

Referring to FIG. 11B, when there is a situation to provide information to a user (e.g., when the user requests to retrieve information or when there is a situation set to output specific information depending on predetermined schedule information), a processor 160 of an information providing device 100 of FIG. 3 may identify the user. For example, the processor 160 may enable a camera 130 of FIG. 3 to capture a face of the user who gazes at the information providing device 100. The processor 160 may compare the captured image of the user with a previously stored face to identify whether the user is any user. Alternatively, the processor 160 may identify an age group of the user through user face analysis. In conjunction with estimating the age group of the user, the information providing device 100 may store and manage previously stored image information for each age group (e.g., a representative image for each age group, feature points extracted from images for each age group, or models extracted based on an image for each age group), which is capable of being compared with the captured image information (e.g., an image, feature points extracted from the image, or a model extracted based on the image) in a memory 140 of FIG. 3.

When the identifying of the user is completed, the processor 160 of the information providing device 100 may configure information to be provided to the user as an image in state 1171 and may output the image on a display 150 of FIG. 3. For example, when the user is a child with an age less than a specified age, the processor 160 may form a screen having relatively more images than text and may output the screen on the display 150.

When the identifying of the user is completed, the processor 160 of the information providing device 100 may configure information to be provided to the user in a form in state 1173 and may output the information on the display 150. For example, the processor 160 may form a screen including relatively more texts than those in state 1171 and may output the screen on the display 150.

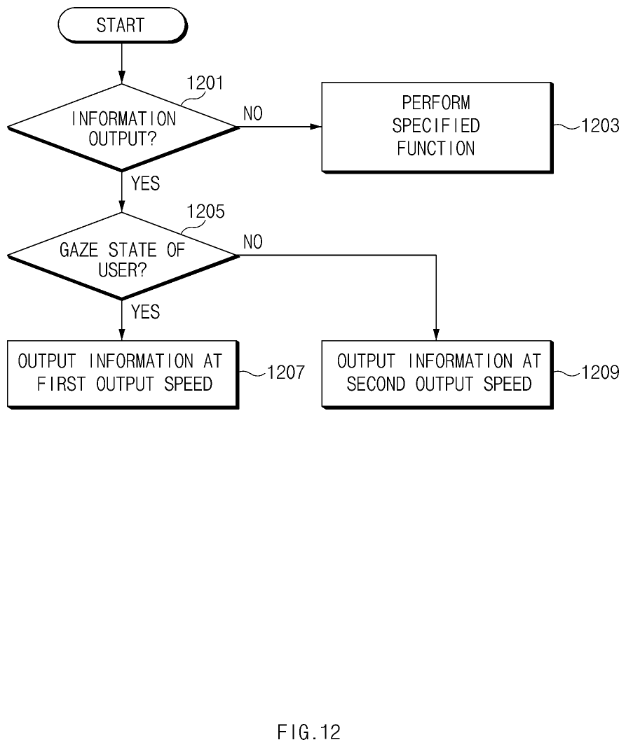

FIG. 12 is a flowchart illustrating another example of an information providing method according to a user state according to an embodiment.

Referring to FIG. 12, in conjunction with the information providing method according to an embodiment, in operation 1201, a processor 160 of an information providing device 100 of FIG. 3 may identify whether an event requesting to output information occurs. For example, the processor 160 may identify whether there is a situation needing to output a user response according to the reception of a user utterance. Alternatively, in response to a request to retrieve user information, the processor 160 may identify whether there is a situation which should output response information (e.g., output information 241 of FIG. 2).

When the generated event is an event unrelated to outputting information, in operation 1203, the processor 160 may perform a specified function corresponding to the event. For example, the processor 160 may play music depending on a predetermined schedule.

When the generated event is an event needing to output information, in operation 1205, the processor 160 may identify a gaze state of a user. In conjunction with identifying the gaze state of the user, the processor 160 may enable a camera 130 of FIG. 3 to capture an image and may identify a gaze direction of the user based on analyzing the captured image. The information providing device 100 may previously store reference information about a state when a gaze direction of the user is toward a display 150 of FIG. 3 and reference information about a state when the gaze direction of the user is not toward the display 150 in a memory 140 of FIG. 3 and may determine the gaze direction of the user by comparing the stored reference information. Alternatively, the processor 160 may analyze information about locations of the eyes of the user and information about locations of the pupils on the eyes and may determine a gaze direction of the user based on the locations of the pupils on the eyes. For example, when each of the pupils is located on the center area of an eye area, the processor 160 may determine that the user gazes at the display 150. Alternatively, when each of the pupils is out of the center of the eye area to be located in the direction of an edge, the processor 160 may determine that the user does not gaze at the display 150. According to certain embodiments, when only one eye is detected from the face of the user or when the eye area is not detected, the processor 160 may determine that the user does not gaze at the display 150.

When the gaze direction of the user is a specified direction (e.g., a direction where the user gazes at at least a part of the display 150), in operation 1207, the processor 160 may output information at a first output speed. In conjunction with a function of controlling to output information at the first output speed (or controlling a change speed of information to be the first output speed), when changing a screen in a slide mode, the processor 160 may match an interval between slides to a predetermined speed to change the screen at the first output speed (e.g., a screen change speed). Alternatively, when playing a video, the processor 160 may control a video playback speed to be a predetermined speed.

When a gaze direction of the user is not toward the display 150, for example, when the gaze direction of the user, which is determined by analyzing eyes and pupils of the user, is not toward the display 150, in operation 1209, the processor 160 may output information at a second output speed. In conjunction with a function of controlling to output the information at the second speed, when changing a screen in the slide mode, the processor 160 may set a screen change interval between slides to be longer than that in operation 1207 to change the screen at a speed slower than the first output speed. Alternatively, when playing a video, the processor 160 may control to play the video to be slower than the video playback speed in operation 1207. Alternatively, when outputting an audio signal, the processor 160 may increase at least one of an interval between a sentences or an interval between a words, such that the audio signal is generally output at a slow speed. In this operation, the processor 160 may set a playback speed of an audio signal corresponding to a sentence or word in the same manner as normal playback to prevent the audio signal from sounding different.

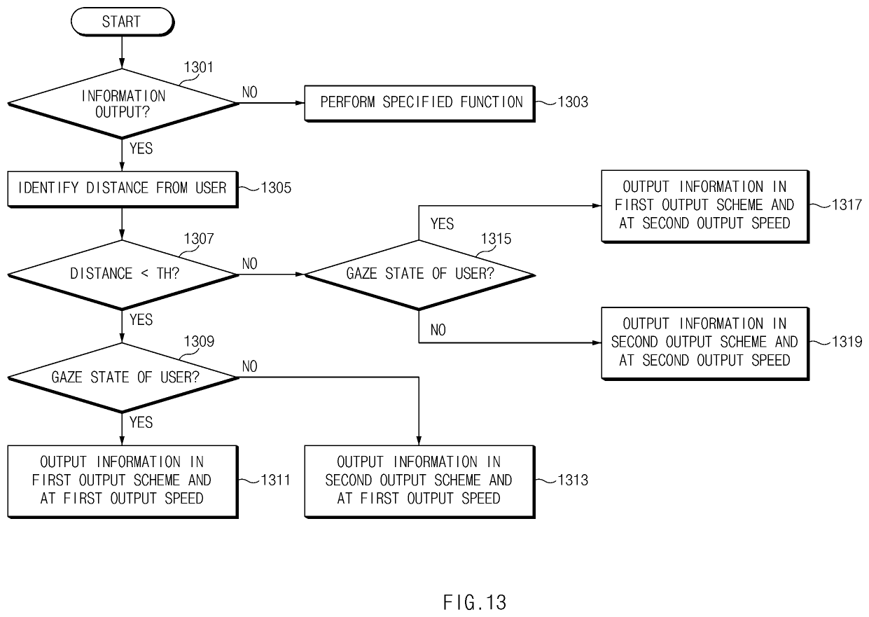

FIG. 13 is a flowchart illustrating another example of an information providing method according to a user state according to an embodiment.

Referring to FIG. 13, in conjunction with the information providing method according to an embodiment, in operation 1301, a processor 160 of an information providing device 100 of FIG. 3 may identify whether the received event is an event requesting to output information. When the event is not the event requesting to output the information, in operation 1303, the processor 160 may perform a specified function according to the event.

When the event is the event requesting to output the information, in operation 1305, the processor 160 may identify a distance from a user. In this regard, the processor 160 may enable a camera 130 of FIG. 3 to capture an image. When a face image in the image is detected, the processor 160 may identify the distance from the user. In this operation, the processor 160 may identify a face size of the user and may estimate the distance from the user by comparing the identified face size with a predetermined reference face size. According to certain embodiments, the processor 160 may obtain an image associated with the user using a depth camera, may form a depth map for the obtained image, and may identify a distance between the user and the information providing device 100 based on the depth map. According to certain embodiments, the processor 160 may calculate a distance between the face of the user and the information providing device 100 using a proximity sensor or a distance sensor. According to certain embodiments, the processor 160 may calculate a distance between the user and the information providing device 100 using a plurality of microphones.

In operation 1307, the processor 160 may identify whether the identified distance is less than a specified reference value TH (or a first range). When the identified distance is less than the specified reference value TH, in operation 1309, the processor 160 may identify a gaze state of the user. In conjunction with identifying the gaze state of the user, as described above with reference to FIG. 12, the processor 160 may capture the face of the user using the camera 130 and may determine whether the user gazes at the display 150 using at least one of eyes and pupils on the captured image. In this operation, the processor 160 may disable the camera 130 to omit to obtain a new image and may identify a gaze state of the user using the captured image used to determine the distance from the user in operation 1305.

When the user gazes at the display 150, in operation 1311, the processor 160 may output information in the first output scheme and at the first output speed. For example, the processor 160 may output information to be output on the display 150, which may control to be played at the specified first output speed (or a first playback speed) or may control a screen change speed to be the first output speed. The processor 160 may output a screen corresponding to information at a predetermined speed on the display 150.

When the user does not gaze at the display 150, in operation 1313, the processor 160 may output information based on a second output scheme and the first output speed. For example, the processor 160 may output audio information corresponding to information to be output through a speaker SPK of FIG. 3, which may output the audio information in response to a predetermined playback speed (e.g., the first output speed).

Meanwhile, when the identified distance between the information providing device 100 and the user is greater than or equal to the specified reference value TH (or the first range) in operation 1307, in operation 1315, the processor 160 may identify a gaze state of the user. The operation of identifying the gaze state of the user in operation 1315 may include the same operation as identifying the gaze state of the user, which is performed in operation 1309.

When the user gazes at the display 150, in operation 1317, the processor 160 may output information in the first output scheme and at a second output speed. For example, the processor 160 may output information on the display 150, which may control to output information at the second output speed slower than the first output speed (e.g., the first output speed where a change speed of the output information is specified). Alternatively, the processor 160 may control such that information is output on the display 150 depending on a screen change speed relatively slower than that in operation 1311. For example, the processor 160 may allocate a time when a screen including specific information is output on the display 150 to be longer than that in operation 1311.

When the user does not gaze at the display 150, in operation 1319, the processor 160 may output information based on the second output scheme and the second output speed. For example, the processor 160 may output audio information corresponding to information to be output through the speaker SPK, which may output the audio information in response to a speed slower than that in operation 1317 (e.g., the second output speed slower than the first output speed). In this operation, the processor 160 may control to more extend at least one of an interval between sentences included in an audio signal to be output or an interval between words included in the audio signal than an interval at the first output speed to output the audio signal.

In the above-mentioned description, the operation of determining the distance value and identifying the gaze state of the user is described, but the disclosure is not limited thereto. For example, when it is required to output information in operation 1301 (YES), the processor 160 may identify a gaze state of the user, may determine a distance from the user, and may determine an output scheme and an output speed by determining the gaze state of the user and the distance from the user in a complex manner.

According to certain embodiments, when the distance from the user is greater than a specified first range (or a reference value TH) and when the user is in the gaze state, the processor 160 may form a screen having a second font size greater than a specified first font size and may output the screen of the second font size at the first output speed on the display 150. Alternatively, when the distance from the user is less than the specified first range (or the reference value TH) and when the user is in the gaze state, the processor 160 may form a screen having a third font size smaller than the specified first font size and may output the screen at the first output speed on the display 150.

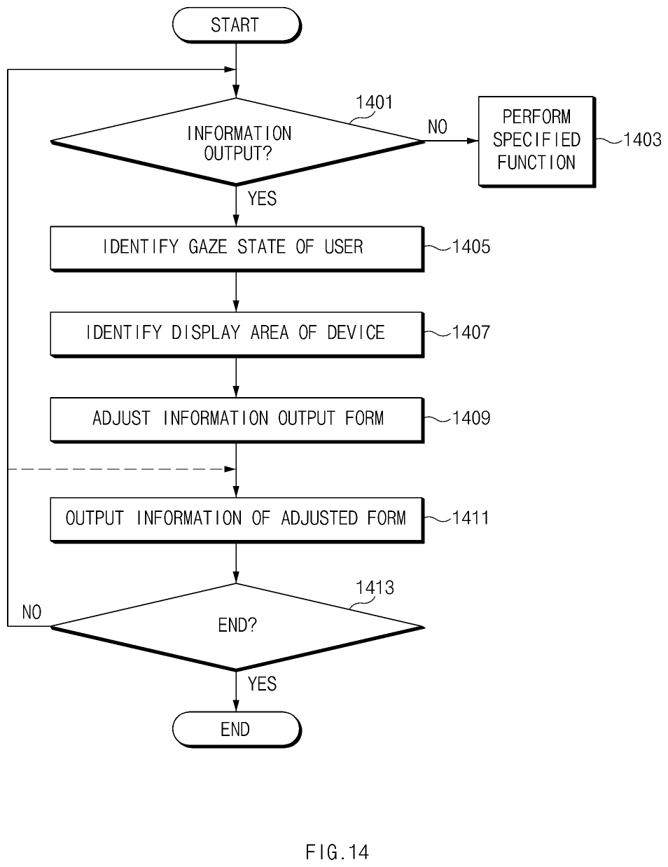

FIG. 14 is a flowchart illustrating an example of an information providing method according to a device characteristic of an information providing device according to an embodiment.

Referring to FIG. 14, in conjunction with the information providing method according to an embodiment, a user management server device 200 of FIG. 1 may establish a communication channel with at least one information providing device 100 of FIG. 1. In operation 1401, the user management server device 200 may identify whether a message received from the at least one information providing device 100 is an event requesting to output information. When the received message is not the event requesting to output the information, in operation 1403, the user management server device 200 may perform a specified function corresponding to the message. For example, the user management server device 200 may collect output information and may store and manage the collected information in a server memory 240 of FIG. 2. Alternatively, the user management server device 200 may be an idle state such that the information providing device 100 may access the user management server device 200.

When the received message is the event requesting to output the information, in operation 1405, the user management server device 200 may identify a device at which a user gazes. In this regard, the user management server device 200 may request the information providing device 100, which transmits the message, to identify whether the user is in a gaze state. In this regard, when the user management server device 200 transmits a message requesting to identify a gaze state of the user to the information providing device 100 which transmits the message, a processor 160 of the information providing device 100 may enable a camera 130 of FIG. 3 to capture an image, may detect a face, eyes, and pupils from the capture image, and may determine a gaze direction of the user based on the detected information. In this operation, the processor 160 may identify whether the user gazes at the information providing device 100. When the user gazes at the information providing device 100, the processor 160 may provide the user management server device 200 with a message for the gaze state of the user.

In operation 1407, the user management server device 200 may identify a display area of the information providing device 100. For example, the user management server device 200 may collect information indicating whether the information providing device 100 includes a display, information about a size of the display, and information about resolution of the display.

When the information providing device 100 includes the display, in operation 1409, the user management server device 200 may adjust an information output form corresponding to the size and resolution of the display. For example, the user management server device 200 may form a screen suitable for the size and resolution of the display included in the information providing device 100. According to certain embodiments, when the information providing device 100 does not include the display, the user management server device 200 may configure information to be provided as an audio.

In operation 1411, the user management server device 200 may output the information of the adjusted form. In this regard, the user management server device 200 may transmit the information, an output type or an output size of which is adjusted, to the information providing device 100.

In operation 1413, when an event of ending the function associated with outputting information occurs, for example, when the communication channel of the information providing device 100 is released, the user management server device 200 may end the information output function. When there is no event of ending the function associated with outputting information, the user management server device 200 may branch to operation 1401 to perform the operation again from operation 1401 or may branch to operation 1411 to perform the operation again from operation 1411.

Meanwhile, in the above-mentioned description, the description is given of the function where the user management server device 200 changes at least one of a form or a size of information to be output, depending on a characteristic (or specification) of an output device of the information providing device 100, which will output information, and provides the changed information to the information providing device 100, but the disclosure is not limited thereto. For example, the function of changing and providing information depending on the characteristic of the output device of the information providing device 100 may be performed between a plurality of information providing devices. For example, when an event needing to output information occurs, a first electronic device (e.g., the specific information providing device 100) may identify a gaze state of the user and may request at least one second electronic device including a camera among other surrounding electronic devices, which establish a communication channel, to identify the gaze state of the user. When the electronic device at which the user gazes among the first electronic device and the second electronic devices is any of the second electronic devices, the second electronic device may provide the first electronic device with a user gaze state message (a message providing a notification that the user gazes at the second electronic device). The first electronic device may identify a characteristic of the output device of the second electronic device which transmits the user gaze state message, may adjust a size, an output form (e.g., a screen or an audio), or resolution of information to suit the characteristic of the output device of the second electronic device, and may provide the second electronic device with the adjusted information. Herein, the second electronic device at which the user gazes may be plural in number. In this case, the first electronic device may adjust information to suit characteristics of output devices of the plurality of second electronic devices and may provide each of the plurality of second electronic devices with the adjusted information. According to certain embodiments, the first electronic device may fail to change information and may transmit the information which is not adjusted to the second electronic device at which the user gazes. The second electronic device at which the user gazes may change and output the received information to suit a characteristic of an output device of the second electronic device.

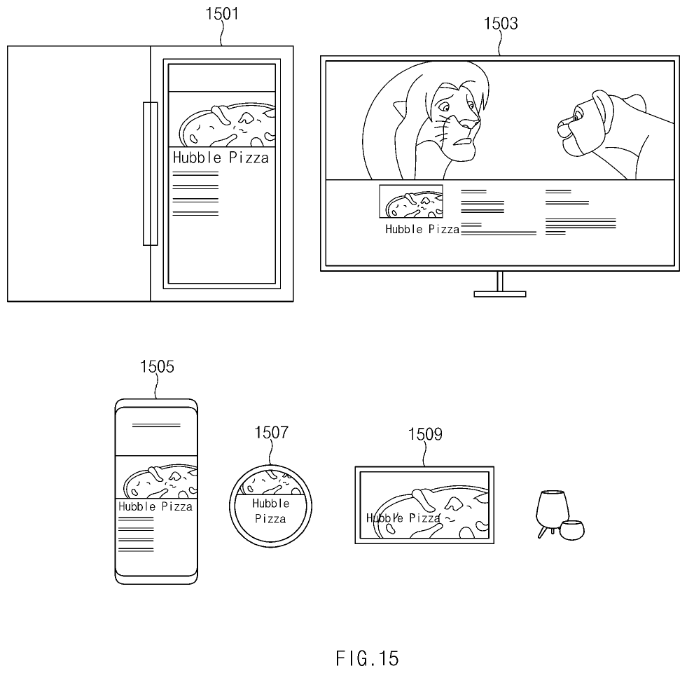

FIG. 15 is a drawing illustrating an example of information adjustment and output according to a characteristic of an information providing device according to an embodiment.

Referring to FIG. 15, when a situation needing to output information occurs, information providing devices 1501, 1503, 1505, 1507, and 1509 may output information of a form adjusted in response to characteristics of their output devices. In this regard, the information providing devices 1501, 1503, 1505, 1507, and 1509 may receive information of a form adjusted in response to a characteristic of an output device of the corresponding device from a user management server device 200 of FIG. 2. According to an embodiment, the hub device 1501 including a display may output information adjusted in response to a size of the display. Furthermore, the TV 1503 may output information adjusted in response to a size of its display. Each of the mobile device 1505, the wearable device 1507, and the display speaker 1509 may output information adjusted in response to a size of its display in an information output process. In conjunction with the above-mentioned operation, each of the information providing devices 1501, 1503, 1505, 1507, and 1509 may enable its camera to identify whether there is a user within an image capture range of the camera. When the user exists within the image capture range of the camera, each of the information providing devices 1501, 1503, 1505, 1507, and 1509 may output the adjusted information. According to certain embodiments, each of the information providing devices 1501, 1503, 1505, 1507, and 1509 may enable its camera to capture an image and may analyze the captured image. When the user gazes at each of the information providing devices 1501, 1503, 1505, 1507, and 1509, each of the information providing devices 1501, 1503, 1505, 1507, and 1509 may output information adjusted in response to a characteristic of its output device. Alternatively, each of the information providing devices 1501, 1503, 1505, 1507, and 1509 may provide a specific information providing device (e.g., a device capable of detecting a gaze direction of the user) with the image obtained by the camera. According to the analyzed result of the specific information providing device, the adjusted information may be output on a display of the information providing device at which the user gazes. In the information output process, additional information may be further displayed other than the information output according to the characteristic of each information providing device. For example, for the TV 1503, after the screen is separated, information, a size of which is adjusted, may be output on a certain area of the separated screen. Alternatively, information having a specified size may be overlaid and displayed on an image display area of the TV 1503. Alternatively, like the display speaker 1509, only image information except for text information may be displayed.

According to certain aspects, an information providing device, comprises a display configured to display information; a camera; and a processor operatively connected with the display, and the camera, wherein the processor is configured to: when there is information to output, determining whether a user is gazing at the display using the camera; output the information at a first output speed with respect to a change speed of the information, when it is determined that the user is gazing at the display; and output the information based on a second output speed slower than the first output speed with respect to the change speed of the information, when it is determined that the user is not gazing at the display.

According to certain embodiments, the processor is configured to: display a display screen for a longer time at the second output speed than at the first output speed.

According to certain embodiments, the processor is configured to: when a screen of the display is in a slide mode, use a longer interval between slides at the second output speed than at the first output speed.

According to certain embodiments, the processor is configured to: when a video is played, output the information at the second output speed slower than a playback speed at the first output speed.

According to certain embodiments, the processor is configured to: when audio information is output, output audio information corresponding to the information at the second output speed slower than the first output speed.

According to certain embodiments, the processor is configured to: when audio information is output, use a longer interval between sentences at the second output speed than at the first output speed.

According to certain embodiments, the processor is configured to: when audio information is output, use a longer interval between words at the second output speed than at the first output speed.

According to certain embodiments, the processor is configured to: calculate a distance from the user and output a screen corresponding to the information at the first output speed on the display, when the distance from the user is outside of a specified first range and when the user is gazing at the display.

According to certain embodiments, the processor is configured to: output a screen, corresponding to the information and having a second font size larger than a specified first font size, when the first output speed is used.

According to certain embodiments, the processor is configured to: output audio information corresponding to the information at the first output speed through a speaker, when the distance from the user is within the specified first range and when the when the user is not gazing at the display.

According to certain embodiments, the processor is configured to: calculate a distance from the user; and output a screen corresponding to the information at the first output speed on the display, when the distance from the user is within a specified first range and when the user is gazing at the display.

According to certain embodiments, the processor is configured to: output a screen, corresponding to the information and having a third font size smaller than a specified first font size, at the second output speed on the display.

According to certain embodiments, the processor is configured to: output audio information corresponding to the information at the second output speed through a speaker, when the distance from the user is within the specified first range and user is not gazing at the display.

According to certain embodiments, an information providing method comprises: receiving a user utterance; determining whether a user gazes at a display of an information providing device by capturing an image with a camera; outputting response information corresponding to the user utterance based on a first output speed, when the image indicates the user gazes at the display; and outputting the response information based on a second output speed slower than the first output speed, when the image indicates that the user does not gaze at the display.

According to certain embodiments, the method further comprises calculating a distance from the user, wherein the outputting includes: outputting a screen corresponding to the information at the first output speed on the display, when the distance from the user is outside of a specified first range and when the image is obtained.

According to certain embodiments, the outputting of the screen on the display further comprises: outputting the screen, corresponding to the information and having a second font size larger than a specified first font size, at the first output speed on the display.

According to certain embodiments, the outputting includes: outputting audio information corresponding to the information at the first output speed through a speaker of the information providing device, when the distance from the user is within the specified first range and when the image indicates that the user does not gaze at the display.

According to certain embodiments, the method further comprises: calculating a distance from the user, wherein the outputting includes: outputting a screen corresponding to the information at the first output speed on the display, when the distance from the user is within a specified first range and when the image indicates that the user gazes at the display.

According to certain embodiments, the outputting of the screen on the display includes: outputting the screen, corresponding to the information and having a third font size larger than a specified first font size, at the second output speed on the display.

According to certain embodiments, the outputting includes: outputting audio information corresponding to the information at the second output speed through a speaker of the information providing device, when the distance from the user is within the specified first range and the image indicates that the user does not gaze at the display.

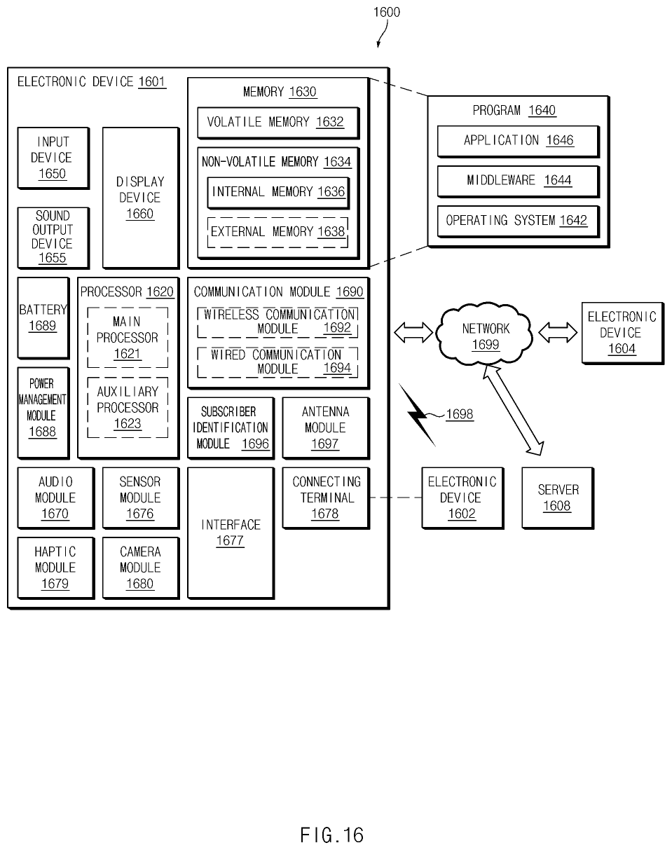

FIG. 16 is a block diagram illustrating an electronic device 1601 in a network environment 1600 according to certain embodiments. Referring to FIG. 16, the electronic device 1601 in the network environment 1600 may communicate with an electronic device 1602 via a first network 1698 (e.g., a short-range wireless communication network), or an electronic device 1604 or a server 1608 via a second network 1699 (e.g., a long-range wireless communication network). According to an embodiment, the electronic device 1601 may communicate with the electronic device 1604 via the server 1608. According to an embodiment, the electronic device 1601 may include a processor 1620, memory 1630, an input device 1650, a sound output device 1655, a display device 1660, an audio module 1670, a sensor module 1676, an interface 1677, a haptic module 1679, a camera module 1680, a power management module 1688, a battery 1689, a communication module 1690, a subscriber identification module (SIM) 1696, or an antenna module 1697. In some embodiments, at least one (e.g., the display device 1660 or the camera module 1680) of the components may be omitted from the electronic device 1601, or one or more other components may be added in the electronic device 1601. In some embodiments, some of the components may be implemented as single integrated circuitry. For example, the sensor module 1676 (e.g., a fingerprint sensor, an iris sensor, or an illuminance sensor) may be implemented as embedded in the display device 1660 (e.g., a display).

The processor 1620 may execute, for example, software (e.g., a program 1640) to control at least one other component (e.g., a hardware or software component) of the electronic device 1601 coupled with the processor 1620, and may perform various data processing or computation. According to one embodiment, as at least part of the data processing or computation, the processor 1620 may load a command or data received from another component (e.g., the sensor module 1676 or the communication module 1690) in volatile memory 1632, process the command or the data stored in the volatile memory 1632, and store resulting data in non-volatile memory 1634. According to an embodiment, the processor 1620 may include a main processor 1621 (e.g., a central processing unit (CPU) or an application processor (AP)), and an auxiliary processor 1623 (e.g., a graphics processing unit (GPU), an image signal processor (ISP), a sensor hub processor, or a communication processor (CP)) that is operable independently from, or in conjunction with, the main processor 1621. Additionally or alternatively, the auxiliary processor 1623 may be adapted to consume less power than the main processor 1621, or to be specific to a specified function. The auxiliary processor 1623 may be implemented as separate from, or as part of the main processor 1621.

The auxiliary processor 1623 may control at least some of functions or states related to at least one component (e.g., the display device 1660, the sensor module 1676, or the communication module 1690) among the components of the electronic device 1601, instead of the main processor 1621 while the main processor 1621 is in an inactive (e.g., sleep) state, or together with the main processor 1621 while the main processor 1621 is in an active state (e.g., executing an application). According to an embodiment, the auxiliary processor 1623 (e.g., an image signal processor or a communication processor) may be implemented as part of another component (e.g., the camera module 1680 or the communication module 1690) functionally related to the auxiliary processor 1623.

The memory 1630 may store various data used by at least one component (e.g., the processor 1620 or the sensor module 1676) of the electronic device 1601. The various data may include, for example, software (e.g., the program 1640) and input data or output data for a command related thereto. The memory 1630 may include the volatile memory 1632 or the non-volatile memory 1634.

The program 1640 may be stored in the memory 1630 as software, and may include, for example, an operating system (OS) 1642, middleware 1644, or an application 1646.

The input device 1650 may receive a command or data to be used by other component (e.g., the processor 1620) of the electronic device 1601, from the outside (e.g., a user) of the electronic device 1601. The input device 1650 may include, for example, a microphone, a mouse, a keyboard, or a digital pen (e.g., a stylus pen).

The sound output device 1655 may output sound signals to the outside of the electronic device 1601. The sound output device 1655 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 1660 may visually provide information to the outside (e.g., a user) of the electronic device 1601. The display device 1660 may include, for example, a display, a hologram device, or a projector and control circuitry to control a corresponding one of the display, hologram device, and projector. According to an embodiment, the display device 1660 may include touch circuitry adapted to detect a touch, or sensor circuitry (e.g., a pressure sensor) adapted to measure the intensity of force incurred by the touch.

The audio module 1670 may convert a sound into an electrical signal and vice versa. According to an embodiment, the audio module 1670 may obtain the sound via the input device 1650, or output the sound via the sound output device 1655 or a headphone of an external electronic device (e.g., an electronic device 1602) directly (e.g., wiredly) or wirelessly coupled with the electronic device 1601.

The sensor module 1676 may detect an operational state (e.g., power or temperature) of the electronic device 1601 or an environmental state (e.g., a state of a user) external to the electronic device 1601, and then generate an electrical signal or data value corresponding to the detected state. According to an embodiment, the sensor module 1676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1677 may support one or more specified protocols to be used for the electronic device 1601 to be coupled with the external electronic device (e.g., the electronic device 1602) directly (e.g., wiredly) or wirelessly. According to an embodiment, the interface 1677 may include, for example, a high definition multimedia interface (HDMI), a universal serial bus (USB) interface, a secure digital (SD) card interface, or an audio interface.

A connecting terminal 1678 may include a connector via which the electronic device 1601 may be physically connected with the external electronic device (e.g., the electronic device 1602). According to an embodiment, the connecting terminal 1678 may include, for example, a HDMI connector, a USB connector, a SD card connector, or an audio connector (e.g., a headphone connector).

The haptic module 1679 may convert an electrical signal into a mechanical stimulus (e.g., a vibration or a movement) or electrical stimulus which may be recognized by a user via his tactile sensation or kinesthetic sensation. According to an embodiment, the haptic module 1679 may include, for example, a motor, a piezoelectric element, or an electric stimulator.

The camera module 1680 may capture a still image or moving images. According to an embodiment, the camera module 1680 may include one or more lenses, image sensors, image signal processors, or flashes.

The power management module 1688 may manage power supplied to the electronic device 1601. According to one embodiment, the power management module 1688 may be implemented as at least part of, for example, a power management integrated circuit (PMIC).

The battery 1689 may supply power to at least one component of the electronic device 1601. According to an embodiment, the battery 1689 may include, for example, a primary cell which is not rechargeable, a secondary cell which is rechargeable, or a fuel cell.

The communication module 1690 may support establishing a direct (e.g., wired) communication channel or a wireless communication channel between the electronic device 1601 and the external electronic device (e.g., the electronic device 1602, the electronic device 1604, or the server 1608) and performing communication via the established communication channel. The communication module 1690 may include one or more communication processors that are operable independently from the processor 1620 (e.g., the application processor (AP)) and supports a direct (e.g., wired) communication or a wireless communication. According to an embodiment, the communication module 1690 may include a wireless communication module 1692 (e.g., a cellular communication module, a short-range wireless communication module, or a global navigation satellite system (GNSS) communication module) or a wired communication module 1694 (e.g., a local area network (LAN) communication module or a power line communication (PLC) module). A corresponding one of these communication modules may communicate with the external electronic device via the first network 1698 (e.g., a short-range communication network, such as Bluetooth™, wireless-fidelity (Wi-Fi) direct, or infrared data association (IrDA)) or the second network 1699 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1692 may identify and authenticate the electronic device 1601 in a communication network, such as the first network 1698 or the second network 1699, using subscriber information (e.g., international mobile subscriber identity (IMSI)) stored in the subscriber identification module 1696.

The antenna module 1697 may transmit or receive a signal or power to or from the outside (e.g., the external electronic device) of the electronic device 1601. According to an embodiment, the antenna module 1697 may include an antenna including a radiating element composed of a conductive material or a conductive pattern formed in or on a substrate (e.g., PCB). According to an embodiment, the antenna module 1697 may include a plurality of antennas. In such a case, at least one antenna appropriate for a communication scheme used in the communication network, such as the first network 1698 or the second network 1699, may be selected, for example, by the communication module 1690 (e.g., the wireless communication module 1692) from the plurality of antennas. The signal or the power may then be transmitted or received between the communication module 1690 and the external electronic device via the selected at least one antenna. According to an embodiment, another component (e.g., a radio frequency integrated circuit (RFIC)) other than the radiating element may be additionally formed as part of the antenna module 1697.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1601 and the external electronic device 1604 via the server 1608 coupled with the second network 1699. Each of the electronic devices 1602 and 1604 may be a device of a same type as, or a different type, from the electronic device 1601. According to an embodiment, all or some of operations to be executed at the electronic device 1601 may be executed at one or more of the external electronic devices 1602, 1604, or 1608. For example, if the electronic device 1601 should perform a function or a service automatically, or in response to a request from a user or another device, the electronic device 1601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1601. The electronic device 1601 may provide the outcome, with or without further processing of the outcome, as at least part of a reply to the request. To that end, a cloud computing, distributed computing, or client-server computing technology may be used, for example.

The electronic device according to certain embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that certain embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 1640) including one or more instructions that are stored in a storage medium (e.g., internal memory 1636 or external memory 1638) that is readable by a machine (e.g., the electronic device 1601). For example, a processor (e.g., the processor 1620) of the machine (e.g., the electronic device 1601) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

It should be appreciated that certain embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

According to the situation, the expression “configured to” used in this disclosure may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

The term “module” used in this disclosure may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to certain embodiments may be, for example, implemented by instructions stored in a computer-readable storage media (e.g., the memory 1630) in the form of a program module. The instruction, when executed by a processor (e.g., the processor 1620), may cause the one or more processors to perform a function corresponding to the instruction. A computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), and hardware devices (e.g., a read only memory (ROM), a random access memory (RANI), or a flash memory). Also, a program instruction may include not only a mechanical code such as things generated by a compiler but also a high-level language code executable on a computer using an interpreter.

According to certain embodiments, each component (e.g., a module or a program) may include a single entity or a plurality of entities. Some of the above-described sub-components may be omitted, or other sub-components may be added. Alternatively or additionally, some components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

According to certain embodiments disclosed in the disclosure, the information providing method and the electronic device for supporting the same may operate elements of the electronic device associated with outputting information in a single or complex manner, may adaptively select and operate an information output device if necessary, and may change information to suit a viewing environment of an information output form, thus enhancing information transmission efficiency and information recognition efficiency.

Furthermore, an embodiment of the disclosure may prevent information the user should obtain from being omitted to support to obtain systematic information and prevent a variety of damage capable of being caused due to information omission.

In addition, various effects ascertained directly or indirectly through the disclosure may be provided.

While the disclosure has been shown and described with reference to certain embodiments thereof, it will be understood by those skilled in the art that various changes in form and details may be made therein without departing from the spirit and scope of the disclosure as defined by the appended claims and their equivalents.

What is claimed is:

1. An information providing device, comprising:
a display configured to display information;
a camera; and
a processor operatively connected with the display, and the camera,
wherein the processor is configured to:
when there is information to output, determining whether a user is gazing at the display using the camera;
output the information at a first output speed with respect to a change speed of the information, when it is determined that the user is gazing at the display; and
output the information based on a second output speed slower than the first output speed with respect to the change speed of the information, when it is determined that the user is not gazing at the display.

2. The information providing device of claim 1, wherein the processor is configured to:
display a display screen for a longer time at the second output speed than at the first output speed.

3. The information providing device of claim 1, wherein the processor is configured to:
when a screen of the display is in a slide mode, use a longer interval between slides at the second output speed than at the first output speed.

4. The information providing device of claim 1, wherein the processor is configured to:
when a video is played, output the information at the second output speed slower than a playback speed at the first output speed.

5. The information providing device of claim 1, wherein the processor is configured to:
when audio information is output, output audio information corresponding to the information at the second output speed slower than the first output speed.

6. The information providing device of claim 1, wherein the processor is configured to:
when audio information is output, use a longer interval between sentences at the second output speed than at the first output speed.

7. The information providing device of claim 1, wherein the processor is configured to:
when audio information is output, use a longer interval between words at the second output speed than at the first output speed.

8. The information providing device of claim 1, wherein the processor is configured to:
calculate a distance from the user and output a screen corresponding to the information at the first output speed on the display, when the distance from the user is outside of a specified first range and when the user is gazing at the display.

9. The information providing device of claim 8, wherein the processor is configured to:
output a screen, corresponding to the information and having a second font size larger than a specified first font size, when the first output speed is used.

10. The information providing device of claim 8, wherein the processor is configured to:
output audio information corresponding to the information at the first output speed through a speaker, when the distance from the user is within the specified first range and when the when the user is not gazing at the display.

11. The information providing device of claim 1, wherein the processor is configured to:
calculate a distance from the user; and
output a screen corresponding to the information at the first output speed on the display, when the distance from the user is within a specified first range and when the user is gazing at the display.

12. The information providing device of claim 11, wherein the processor is configured to:
output a screen, corresponding to the information and having a third font size smaller than a specified first font size, at the second output speed on the display.

13. The information providing device of claim 11, wherein the processor is configured to:
output audio information corresponding to the information at the second output speed through a speaker, when the distance from the user is within the specified first range and user is not gazing at the display.

14. An information providing method, comprising:
receiving a user utterance;
determining whether a user gazes at a display of an information providing device by capturing an image with a camera;
outputting response information corresponding to the user utterance based on a first output speed, when the image indicates the user gazes at the display; and
outputting the response information based on a second output speed slower than the first output speed, when the image indicates that the user does not gaze at the display.

15. The information providing method of claim 14, further comprising:
calculating a distance from the user,
wherein the outputting includes:
outputting a screen corresponding to the information at the first output speed on the display, when the distance from the user is outside of a specified first range and when the image is obtained.

16. The information providing method of claim 15, wherein the outputting of the screen on the display further comprises:
outputting the screen, corresponding to the information and having a second font size larger than a specified first font size, at the first output speed on the display.

17. The information providing method of claim 15, wherein the outputting includes:
outputting audio information corresponding to the information at the first output speed through a speaker of the information providing device, when the distance from the user is within the specified first range and when the image indicates that the user does not gaze at the display.

18. The information providing method of claim 14, further comprising:
calculating a distance from the user,
wherein the outputting includes:
outputting a screen corresponding to the information at the first output speed on the display, when the distance from the user is within a specified first range and when the image indicates that the user gazes at the display.

19. The information providing method of claim 18, wherein the outputting of the screen on the display includes:
outputting the screen, corresponding to the information and having a third font size larger than a specified first font size, at the second output speed on the display.

20. The information providing method of claim 18, wherein the outputting includes:
outputting audio information corresponding to the information at the second output speed through a speaker of the information providing device, when the distance from the user is within the specified first range and the image indicates that the user does not gaze at the display.
